(19) United States
(12) Patent Application Publication
(10) Pub. No.: US 2011/0227304 A1
(43) Pub. Date: Sep. 22, 2011

(54) SHOCK-PROOF DRAG WHEEL

(76) Inventor: Chu Shan LAI, Xinzhuang City (TW)

(21) Appl. No.: 12/836,287

(22) Filed: Jul. 14, 2010

(30) Foreign Application Priority Data
Mar. 16, 2010 (TW) 99204601

(51) Int. Cl. B60B 33/02

(52) U.S. Cl. 280/81.6

(57) ABSTRACT

A shock-proof drag wheel is disclosed. Wherein, on its base is provided with a fixed axis and an indentation portion, a connection rod is disposed on said fixed axis and is connected to an elastic body, and it is swayed and vibrated around said fixed axis. A central axis passes through said connection rod and is located in said indentation portion, and said drag wheel is provided in said indentation portion. When said drag wheel is made to move, the spring force of said elastic body will brake said connection rod in reverse, which in turn bring said central axis into motion in reverse, thus stabilizing said drag wheel and buffering the force generated by the vibrations as caused by said drag wheel passing through uneven ground or indentations on the ground, hereby effectively achieving shock-proof.

### BACKGROUND OF THE INVENTION

1. Field of the Invention

The present invention relates to a luggage trunk drag wheel structure, and in particular to a shock-proof drag wheel, that is capable of enhancing the stability of a luggage trunk while it is being dragged along.

2. The Prior Arts

Presently on the market, luggage trunks of various designs are available, such that people may put their objects of daily usage therein, and take on various transportation means, such as vehicle, high speed train, passenger liner, and airplane for travelling extensively to various parts of the world to engage in business or sightseeing activities.

In the early days, luggage trunk is designed to have a handle for the convenience of carrying the luggage trunk. However, in carrying a luggage trunk while moving and walking is rather tedious and inconvenient, so the bottom of the luggage trunk is additionally provided with drag wheels, such that people may drag the luggage trunk along while moving.

By way of example, Taiwan Patent Number M282852 discloses an improved structure of luggage trunk foot wheel. Wherein, the bottom of an ordinary luggage trunk is provided with two or four rotatable foot wheels, each composed mainly of a wheel base and a rolling wheel. The rolling wheel is disposed at the front end of the wheel base, in the center of the wheel base front end is provided with a revolving wheel, and a braking device is disposed between the wheel base and the rolling wheel. In this kind of foot wheel design, while dragging a luggage trunk, its foot wheel can be kept to move forward in a fixed direction, as such preventing the luggage trunk from swaying and vibrating while being dragged along. However, since this kind of foot wheel does not have shock-proof capabilities, such that when a dragged along luggage trunk passing through an uneven ground or indentions on the ground, the impact of collision between the foot wheel and ground is increased, and plus the weight of luggage trunk itself, that would cause the instability in dragging, or even the broken down of the foot wheel.

Therefore, presently, the design and performance of the foot wheel of the prior art is not quite satisfactory, and it has much room for improvements.

### SUMMARY OF THE INVENTION

In view of the problems and shortcomings of the prior art, the present invention provides a shock-proof drag wheel which is simple in design and construction, capable of being dragged along stably and smoothly, and reducing the shock incurred effectively.

A major objective of the present invention is to provide a shock-proof drag wheel, wherein an elastic body is used to brake the connection rod reversely, reduce significantly the impact of drag wheel collision, and lower the gravitation center of the luggage trunk load, hereby stabilizing the movement of the drag wheel and achieving the effect of shock-proof.

Another objective of the present invention is to provide a shock-proof drag wheel, that is simple in structure, and can be combined easily with various types of luggage trunks, thus realizing practical application facilely.

In order to achieve the above mentioned objective, the present invention provides a shock-proof drag wheel, comprising: a base, a connection rod, an elastic body, a central axis, and at least a drag wheel. On the base is provided with a fixed axis, and it is also provided with an indentation portion. The connection rod is disposed in the fixed axis, and the central axis is located in the indentation portion, such that it is disposed passing through the connection rod. The elastic body is connected to the base and the connection rod respectively, and the drag wheel is provided on the central axis, thus the movement of the drag wheel will cause displacement of the central axis in the indentation portion, and the connection rod is brought to move around the fixed axis. As such, the elastic body connected to the connection rod is used to brake the connection rod in reverse, thus bringing the central axis in stabilizing the displacement of the drag wheel in reverse.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a perspective view of the shock-proof drag wheel according to the present invention;

FIG. 2 is an exploded view of the shock-proof drag wheel according to the present invention;

FIG. 3 is a cross section view of the shock-proof drag wheel before movement according to the present invention;

FIG. 4 is a cross section view of the shock-proof drag wheel during movement according to the present invention; and

FIG. 5 is a schematic diagram of a shock-proof drag wheel installed on a luggage truck according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

The present invention provides a shock-proof drag wheel, wherein, the spring force of an elastic body is used to brake the connection rod in reverse in bringing the central axis into motion in reverse, thus achieving stabilization of the drag wheel. In the following, the embodiment of the present invention is described in explaining the technical characteristics of the present invention.

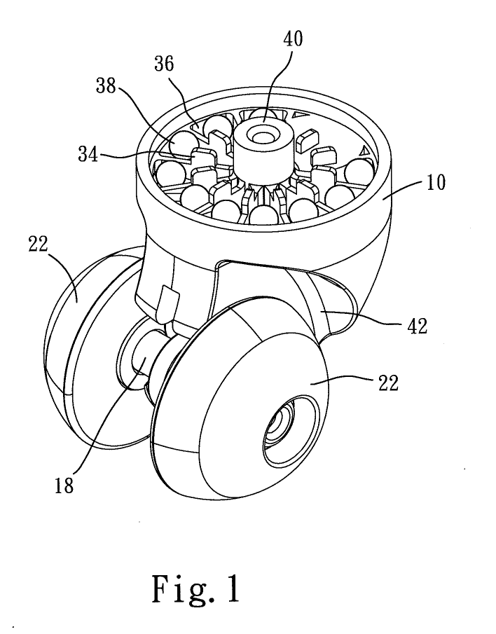

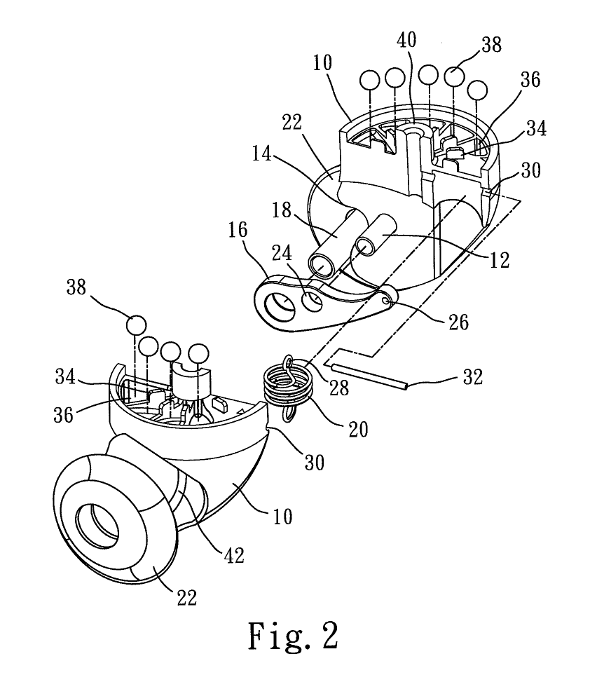

Firstly, refer to FIG. 1 for a perspective view of a shock-proof drag wheel according to the present invention. Also, refer to FIG. 2 at the same time for an exploded view of the shock-proof drag wheel according to the present invention. As shown in FIGS. 1 & 2, the drag wheel of the present invention includes: a base 10, having a fixed axis 12 disposed thereon, and an indentation portion 14 of a half arc shape is provided in a position of a fixed axis 12 corresponding to the base 10; a connection rod 16, with its central portion provided with a connection hole 24, such that the connection rod 16 is connected to the fixed axis 12 through the connection hole 24, so as to be located in the base 10, one end of the connection rod 16 is exposed to the indentation portion 14, and a central axis 18 is disposed passing through the connection rod 16, so as to be located in the indentation portion 14; a hole 26 is provided on the connection rod 16, such that an elastic body 20 serving as a compression elastic body or extension elastic body in the base 10 runs through the hole 26 to connect the connection rod 16; at least a drag wheel 22, provided on the central axis 18, is located on both ends of the central axis 18; and at least an indentation portion 42 is provided in the base 10 corresponding to the drag wheel 22, so as to accommodate the drag wheel 22. Therefore, the movement of the drag wheel 22 will bring the central axis 18 to move between an upper and a lower ends of the an indentation portion 14, thus the connection rod 16 is brought to move by the central axis 18 around the fixed axis 12 at the same time, such that the spring force of the elastic body 20 will brake the connection rod 16 in reverse in bringing the central axis 18 to move in reverse, hereby stabilizing the displacement of the drag wheel 22.

In addition, holes 30 and 28 are provided on the base 10 and the elastic body 20 respectively and are corresponding to each other, and a pin 32 is disposed passing through holes 28 and 30, such that the elastic body 20 is installed and fixed in the base 10. Moreover, a connection portion 40 is provided in the base 10, such that the base 10 can be installed to the luggage trunk through the connection portion 40. A plurality of fins 34 are provided in the base 10, so that an accommodation space 36 is formed between two adjacent fins 34 for accommodating the balls 38, such that the base 10 installed to the luggage trunk is able to rotate by means of the balls 38.

In the above descriptions, the structure of the shock-proof drag wheel is described, and in the following, the operation principle is described for the elastic body 20 to brake the connection rod 16 in reverse in stabilizing the movement of the drag wheel 22.

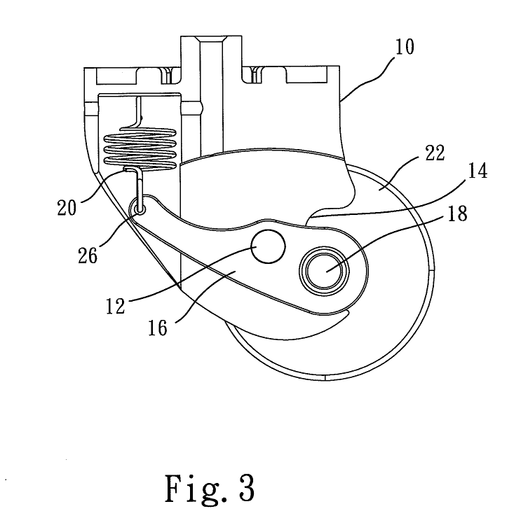

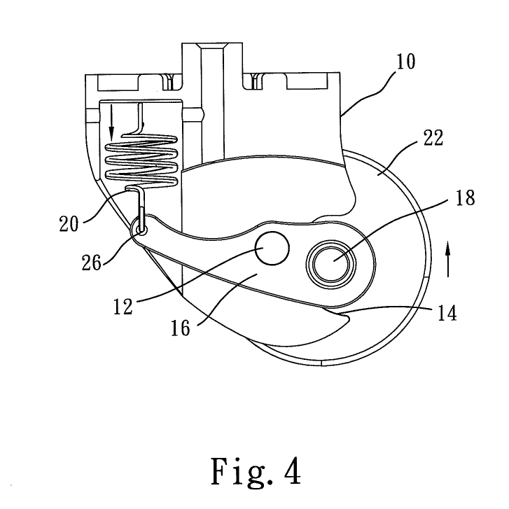

Subsequently, refer to FIG. 3 for a cross section view of the shock-proof drag wheel before movement according to the present invention; also refer to FIG. 4 for a cross section view of the shock-proof drag wheel during movement according to the present invention. As shown in FIGS. 3 and 4, when the drag wheel 22 is in a stable position and a displacement has not occurred, then the central axis 18 is not brought to move, and it has not made a displacement, therefore, it is in the lower end of indentation portion 14. At this time, the connection rod 16 has not been brought to move by the central axis 18, thus the elastic body 20 remains in a stable position, and it is not pulled by the connection rod 16.

When the drag wheel 22 travels through an indentation on the ground and thus a vibration occurs, the drag wheel 22 is made to move from the lower end of the indentation portion 14 to its upper end, as such bringing the central axis 18 to move, and that in turn will bring the connection rod 16 into motion, such that the elastic body 20 is pulled downward by the connection rod 16. However, the spring force of the elastic body 20 will counter act against the downward pulling force generated by the connection rod 16 as caused by the vibration, and it will brake the connection rod 16 in reverse, and thus bringing the central axis 18 to move in reverse, so as to offset the force produced by the vibration when the drag wheel 22 travels through an indentation, hereby stabilizing the drag wheel 22 in achieving the effect of shock-proof.

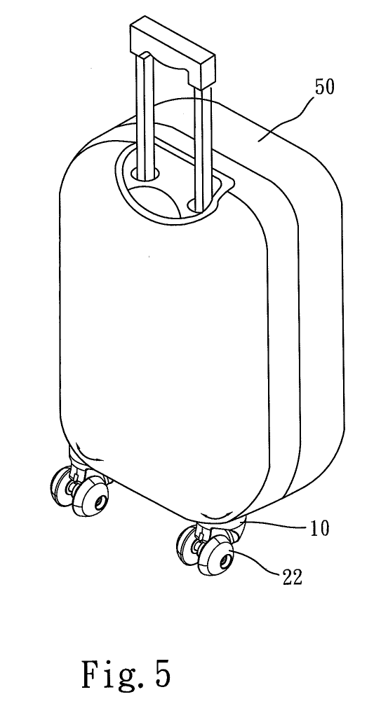

Finally, refer to FIG. 5 for a schematic diagram of a shock-proof drag wheel installed on a luggage truck according to the present invention. As shown in FIG. 5, in the present invention, the shock-proof drag wheel is installed on the bottom of a luggage trunk 50, so as to facilitate the user to pull and drag the luggage truck while travelling. In this process, the force generated by the vibration when the drag wheel 22 passes through an uneven ground or an indentation on the ground can be offset by the counter spring force of the elastic body 20, hereby buffering the shock in achieving shock-proof. As such, the user will not encounter difficulties in pulling and dragging the luggage trunk 50 due to the vibration. Moreover, when the load of the luggage trunk 50 is heavier, the gravitation center of the luggage trunk 50 can be made lower by means of the elastic body 20, thus achieving stable pulling and dragging of the luggage trunk 50.

Through the design of the shock-proof drag wheel of the present invention, the effect of vibration produced by dragging the luggage trunk 50 can be effectively reduced. Wherein, the elastic body 20 is used to brake the connection rod 16 in reverse to stabilize the drag wheel 22 in achieving the shock-proof effect, thus it requires less efforts and strength in pulling and dragging the luggage trunk 50 while travelling. Furthermore, an additional advantage of the drag wheel of the present invention is its simple construction, so that it can be installed easily and facilely on the luggage trunk 50, therefore, it can be utilized in various kinds of luggage trunks.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A shock-proof drag wheel, comprising:
a base, with a fixed axis disposed thereon, and is provided with an indentation portion;
a connection rod, disposed on said fixed axis, and a central axis is located in said indentation portion passing through said connection rod, and an elastic body is disposed in said base and is connected to said connection rod; and
at least a drag wheel, disposed on said central axis, thus movement of said drag wheel will bring said central axis to move in said indentation portion, and that in turn will bring said connection rod to move around said fixed axis, such that said elastic body will brake said connection rod in reverse, in bringing said central axis to move in reverse, hereby stabilizing said drag wheel.

2. The shock-proof drag wheel as claimed in claim 1, wherein said connection rod is provided with a connection hole, such that said connection rod is connected to said fixed axis through said connection hole.

3. The shock-proof drag wheel as claimed in claim 1, wherein said connection rod is provided with a hole, such that said elastic body is connected to said connection rod through said hole.

4. The shock-proof drag wheel as claimed in claim 1, wherein said elastic body is provided with a hole, and said base is provided with an opening corresponding to said hole, such that a pin is disposed in said base passing through said hole and said opening, thus fixing said elastic body to said base.

5. The shock-proof drag wheel as claimed in claim 1, wherein said drag wheel is disposed on both sides of said central axis.

6. The shock-proof drag wheel as claimed in claim 1, further comprising:
a plurality of fins are provided in said base, such that an accommodation space is formed between two said adjacent fins.

7. The shock-proof drag wheel as claimed in claim 6, further comprising:
a plurality of balls are disposed in said accommodation space, such that said base installed on said luggage trunk is rotatable by means of said balls.

8. The shock-proof drag wheel as claimed in claim 7, wherein said base is provided with a connection portion, such that said base is connected to said luggage trunk by means of said connection portion.

9. The shock-proof drag wheel as claimed in claim 1, wherein said base is provided with at least said indentation portion corresponding to said drag wheel, so as to accommodate said drag wheel.

10. The shock-proof drag wheel as claimed in claim 1, wherein said elastic body is a compression spring or an extension spring.
